(19) United States
(12) Patent Application Publication
(10) Pub. No.: US 2002/0157378 A1
(43) Pub. Date: Oct. 31, 2002

(54) Jet engine

(76) Inventor: Konrad Vogeler, Rheinheim (DE)

Correspondence Address: Robert S. Swecker, BURNS, DOANE, SWECKER & MATHIS, L.L.P., P.O. Box 1404, Alexandria, VA, 22313-1404, US

(21) Appl. No.: 09/814,835

(22) Filed: Mar. 23, 2001

Related U.S. Application Data
(63) Continuation-in-part of application No. 09/102,799, filed on Jun. 23, 1998, now abandoned.

(30) Foreign Application Priority Data
Jun. 26, 1997 (DE) 197 26 975.3

(51) Int. Cl. F02K 3/04

(52) U.S. Cl. 60/226.1

(57) ABSTRACT

In a jet engine having a fan (9) of conventional type, a second combustion chamber (5) is provided downstream of the turbine (4), and a second turbine (6) acts downstream of this second combustion chamber (5). The hot gases (16) partly expanded in the first turbine (4) are brought up to temperature again in the second combustion chamber (5), whereby, at a low absolute hot-gas temperature, more output is then available in the engine. A bypass flow nozzle (10) is coaxially arranged with a compressor unit (1, 2) such that the compressed intake air mass flow (12) is divided up into an inner flow entering the compressor unit (1, 2) and a bypass flow expanding in the bypass flow nozzle (10), wherein the ratio of bypass and inner flow is high in order to achieve a substantial contribution to the total thrust of the engine by the bypass flow. At least one compressor (2) belonging to the compressor unit, the first turbine (4) and the second turbine (6) are arranged on a common rotor shaft (7) operatively connected with the fan (9) by a gear unit (8), such that the fan (9) is driven by the excess shaft output of the common rotor shaft (7).

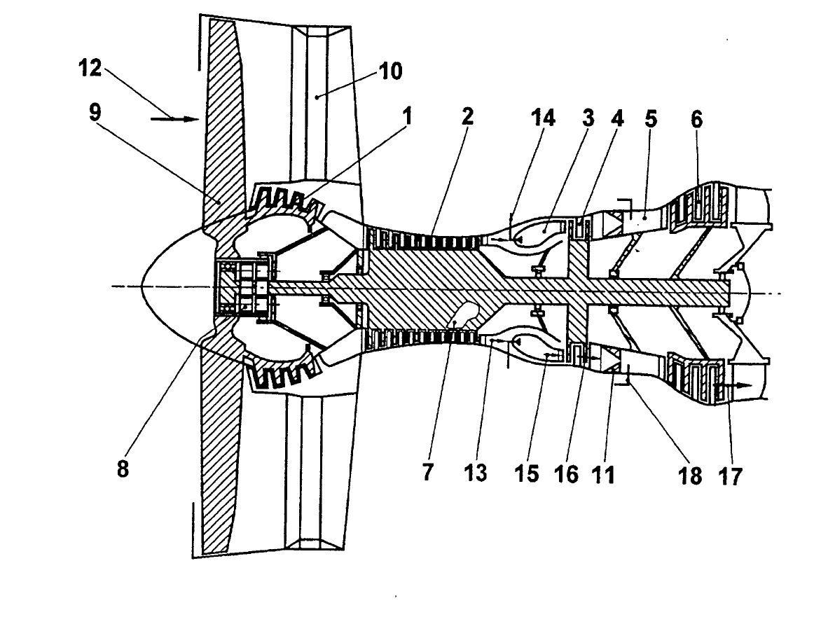

This application is a C-I-P of U.S. patent application Serial No. 09/102,799, filed Jun. 23, 1998, entitled “Jet Engine”, which corresponds and claims priority under 35 U.S.C. §119 to German Application Number 197 26 975.3, filed Jun. 26, 1997, the entire contents of both of which arc incorporated by reference herein.

### BACKGROUND OF THE INVENTION

1. Field of the Invention

The present invention relates to a jet engine.

2. Discussion of Background

Modern jet engines have single- or multi-shaft arrangements. Typically, the gas-turbine group is divided into a high-pressure component and a low-presssure component. The high-pressure component consists of a high-pressure compressor, a combustion-chamber unit, and a high-pressure turbine. The compressor and turbine of the high-pressure component are fastened to a common rotor shaft. A low-pressure compressor and, in the case of a bypass-flow engine, a fan are located upstream of the high-pressure compressor. A low-pressure turbine is arranged directly following the high-pressure turbine. The fan, the low-pressure compressor and the low-pressure turbine form the low-pressure component of the engine. This low-pressure component can be arranged with the high-pressure component on a common rotor shaft. In modern high-performance engines, however, the high-pressure component normally has a separate, second rotor shaft, sometimes even a third rotor shaft, which runs in the high-pressure rotor shaft in a coaxially mounted manner. In this way, different rotational speeds can be realized for the low-presssure part and the high-pressure part.

A common feature of all commonly used types of construction is that they only have a single combustion-chamber unit downstream of the compressor group.

The maximum combustion temperature permissible in this combustion-chamber unit is technologically limited. It has been continuously increased in recent years. The combination of cooling technique and material in the gas turbine and the combustion technique used in the combustion-chamber unit for the purpose of adhering to the legally permissible pollutant emissions set the limits here.

Accordingly, for a mass flow predetermined by the process control in the engine at the combustion-chamber inlet, the possible amount of energy supplied by the fuel is limited by this maximum permissible combustion temperature. As a result, the total output of the engine for a given division of the mass flow is also limited.

### SUMMARY OF THE INVENTION

Accordingly, one object of the invention, as defined in the claims, in a jet engine of the type mentioned at the beginning, is to extend the technologically determined output limit described above by pursuing novel methods in order to achieve greater outputs at the same technological level.

An essential advantage of the invention may first of all be seen in the fact that the engine according to the invention, at the same output, has a markedly reduced fuel consumption compared with an engine according to the state of the art, whereby not only does the efficiency then increase but the specific pollutant emissions also decrease in a striking manner.

A further essential advantage of the invention is connected with the ratio of bypass and inner flow: the greater this ratio is, the more favorable is the fuel consumption of an engine. To this end, as much output as possible must be available in the fan, and this output is converted into thrust at the bypass-flow ratio.

The advantages of the invention may then be seen essentially in the fact that a second combustion chamber is provided in which the hot gases partly expanded in the first turbine are brought up to temperature again, whereby, at the same maximum hot-gas temperature, more output is then available in the engine.

Advantageous and expedient developments of the achievement of the object according to the invention are defined in the further dependent claims.

### BRIEF DESCRIPTION OF THE DRAWING

A more complete appreciation of the invention and many of the attendant advantages thereof will be readily obtained as the same becomes better understood by reference to the following detailed description when considered in connection with the accompanying drawing, wherein the single figure shows a cross section through a jet engine in bypass-flow embodiment.

All the elements not required for the direct understanding of the invention have been omitted. The direction of flow of the media is indicated by arrows.

### DESCRIPTION OF THE PREFERRED EMBODIMENTS

Referring now to the drawing, in the engine shown, which is characterized by a single rotor shaft 7, the intake air 12 is compressed in a fan 9, in a low-pressure compressor 1, and then in a high-pressure compressor 2. This compressed air 13 then flows into a first combustion chamber 3, in which the maximum temperature permitted from a technological point of view is achieved by the feeding of preferably a liquid fuel 14. The hot gas 15 prepared in this combustion chamber 3 is partly expanded in a first turbine 4 and delivers output to the rotor shaft 7. The partly expanded hot gases 16 leave the first turbine 4 at a lower temperature and then flow into a second combustion chamber 5, in which these hot gases 16 are processed a second time to the maximum temperature. The combustion techniques in the first and second combustion chambers will be dealt with in more detail further below. After the gases in the second combustion chamber 5 have been heated again to maximum temperature, they are then expanded in a downstream second turbine 6, with corresponding delivery of output to the rotor shaft 7. The finally expanded gases 17, that is, the exhaust gases, then leave the engine through a thrust nozzle (not shown in any more detail in the drawing). Some of the shaft output is removed by the high-pressure compressor 2 attached to the rotor shaft 7. Since the rotor shaft has too high a rotational speed for the fan 9, this rotational speed is reduced for the benefit of the latter by a gear unit 8 to such an extent that the fan 9 is then reliably controlled mechanically. The air mass flow 12 entering the engine is compressed in a first stage by the fan 9; this mass flow then divides into an inner flow and a bypass flow. The bypass flow then expands in a bypass-flow nozzle 10 and makes a substantial contribution to the total thrust of the engine.

The greater the ratio of bypass flow and inner flow, the more favorable is the fuel consumption of an engine. Seen in this way, it is therefore important to have as much output available in the fan 9 as possible, in order to consistently realize a high bypass-flow ratio.

The compression to the final pressure, which at the same time also forms the maximum pressure in the engine, must always be completed upstream of the first combustion chamber.

The reason for the proposed single-shaft principle may be seen in the fact that, in the case of a multi-shaft engine, the high-pressure turbine on the high-pressure shaft must take so much output from the gas flow to drive the high-pressure compressor that the pressure downstream of the high-pressure turbine is then no longer high enough for a further output feed in the second combustion chamber up to the maximum temperature in order to sufficiently reduce this output in the low-pressure turbine. The result of such a configuration would then be an unacceptably low efficiency of the plant.

In contrast, if the entire gas-turbine group of the engine is arranged on a single rotor shaft 7, the low-pressure turbine 6 can help to drive the high-pressure compressor 2, whereby the output division can be made more favorable. The excess shaft output is fed via the gear unit 8 to the slower-running fan 9. The number of bearings of the rotor shaft 7 is established from case to case.

For better reaction to varying output requirement, the fan 9 is equipped with adjustable blades. Furthermore, it may be appropriate for particular applications for the fan 9 to be of multi-stage design.

The first combustion chamber 3 is of annular configuration, in which case this combustion chamber may also consist of a number of self-contained combustion spaces arranged axially, quasi-axially or helically around the rotor shaft 7. On the head side, the annular combustion chamber 3 taken as a basis here has a number of burners (not shown in any more detail), which are distributed over the periphery and generate the hot gases. Diffusion burners may also be used here per se. For reducing the pollutant emissions from this combustion, in particular as far as the NOx emissions are concerned, it is advantageous to provide an arrangement of premix burners according to EP-B-0 321 809, the subject matter of the invention from this publication being an integral part of this description.

As far as the arrangement of the premix burners in the peripheral direction of the annular combustion chamber 3 is concerned, such an arrangement, if required, may differ from the conventional configuration of identical burners distributed over the periphery. Premix burners of different size may be used instead. This is preferably done in such a way that a small premix burner of preferably the same configuration is disposed in each case between two large premix burners. The size of the large premix burners, which have to fulfill the function of main burners, in relation to the small premix burners, which are the pilot burners of this combustion chamber, is established from case to case with regard to the burner air passing through them, that is, the compressed air from the compressor unit. The pilot burners work as independent premix burners over the entire load range of the combustion chamber, the air coefficient remaining virtually constant. Since the pilot burners can be run on an ideal mixture over the entire load range, the NOx emissions are very low even at part load. In such a configuration, the encircling flow lines in the front region of the annular combustion chamber 3 come very close to the vortex centers of the pilot burners, so that an ignition per se is only possible with these pilot burners. During run-up to power, the fuel quantity which is fed via the pilot burners is increased until the pilot burners are activated, i.e. until the full fuel quantity is available.

At the peak load of the engine, the main burners are therefore also fully activated. Since the configuration of “small”, hot vortex centers, which is initiated by the pilot burners, between the “large”, cooler vortex centers originating from the main burners turns out to be extremely unstable, very good burn-out with low CO and UHC emissions in addition to the NOx emissions is achieved even in the case of main burners operated on a lean mixture in the part-load range, i.e. the hot vortices of the pilot burners penetrate immediately into the small vortices of the main burners.

The hot gases 15 from the annular combustion chamber 3 are admitted to the first turbine 4 arranged directly downstream, the thermally expanding action of which on the hot gases can be kept variable.

The design of this first turbine 4 influences the temperature of the partly expanded hot gases 16 and thus determines whether the second combustion chamber 5, in interdependence with fuel used there, can be operated according to a self-ignition process.

Here, this second combustion chamber 5 essentially has the form of a continuous annular, axial or quasi-axial cylinder.

As far as the configuration of the annular combustion chamber 5 consisting of a single combustion space is concerned, a plurality of fuel lances 18, which are preferably connected to one another via a ring line (not shown in any more detail), are disposed in the peripheral direction of this annular cylinder. When this second combustion chamber 5 is designed for self-ignition, it has no burner per se: the combustion of the partly expanded hot gases 16 coming from the turbine 4 takes place here by self-ignition. If a liquid fuel is used, temperatures in the order of magnitude of 800° C. are sufficient for an operation based on self-ignition.

In order to ensure the operational reliability and a high efficiency in the case of a combustion chamber designed for self-ignition, it is of the utmost importance that the flame front remains locally stable. For this purpose, a number of vortex-generating elements 11 are provided in this combustion chamber 5 and are preferably disposed on the inner and outer walls in the peripheral direction and are arranged in the axial direction preferably upstream of the fuel lances 18. The task of these so-called vortex generators 11 is to generate lasting vortices which induce a backflow zone in accordance with EP-B-0 321 809. Since this combustion chamber 5, on account of the axial arrangement and the overall length, is a high-velocity combustion chamber whose average velocity is greater than about 60 m/s, the vortex generators 11 must be designed to conform to the flow. On the inflow side, these vortex generators 11 are to preferably consist of a tetrahedral shape having inclined surfaces with respect to the inflow. The vortex generators 11 may be placed on either the outer surface or the inner surface of the combustion chamber 5 or, as the figure shows, may act at both locations. Furthermore, it can be seen from the example shown in the figure that the inclined surfaces between the outer and inner vortex generators 11 are preferably arranged in mirror image in such a way that the cross section of flow of the combustion chamber 5 experiences a vortex-generating expansion downstream of this location in the region of the injection of the fuel 18. The vortex generators 11 may of course also be displaced axially relative to one another. The outflow-side surface of the vortex generators 11 is formed essentially radially, so that a backflow zone appears starting from this location. If self-ignition in the combustion chamber 5 is opted for, such self-ignition must be ensured over all the load ranges, so that auxiliary measures or auxiliary devices are provided, which then intervene in an igniting manner if the self-ignition were no longer ensured for some reason or other.

The short overall length of the combustion chamber 5, the action of the vortex generators 11 for stabilizing the flame as well as the continual guarantee of self-ignition are jointly responsible for the fact that the combustion is effected very quickly, and the dwell time of the fuel in the region of the hot flame front remains minimal. An effect resulting herefrom which is directly measurable from the combustion relates to the NOx emissions, which are minimized in such a way that they are now no longer relevant. Furthermore, this initial situation enables the location of the combustion to be clearly defined, which is reflected in optimized cooling of the structures of this combustion chamber 5. The hot gases prepared in the combustion chamber 5 are then admitted, as already explained above, to the second turbine 6 arranged downstream.

To increase the efficiency of the engine, it is of advantage if a small diffuser (not shown in the figure) is provided upstream of the second combustion chamber 5. The total pressure loss in the entire system can thus be reduced. It can be verified with reference to the conventional diffuser design diagrams that large recovery rates of the dynamic pressure can be achieved even at a minimum length of the diffuser.

Finally, the second annular combustion chamber 5 may be subdivided in the peripheral direction in such a way that a number of individual coordinated combustion spaces maintain the generation of the hot gases. The individual combustion spaces disposed around the rotor shaft 7 may generate the hot gases in a sectional autonomous manner or may be interdependent with one another in an optimum manner from the point of view of combustion.

Numerous modifications and variations of the present invention are possible in light of the above teachings. It is therefore to be understood that, within the scope of the appended claims, the invention may be practiced otherwise than as specifically described herein.

What is claimed is:

1. A jet engine, comprising:
at least one fan including adjustable blades for compressing an intake air mass flow;
a common rotor shaft;
a gear unit operatively connecting the common rotor shaft to the at least one fan;
at least one compressor unit arranged downstream of the fan, the at least one compressor unit including at least one compressor;
a bypass flow nozzle coaxially arranged with the compressor unit such that the compressed intake air mass flow is divided up into an inner flow entering the compressor unit and a bypass flow expanding in the bypass flow nozzle, wherein the ratio of bypass and inner flow is high in order to achieve a substantial contribution to the total thrust of the engine by the bypass flow;
an annular combustion chamber arranged downstream of the compressor unit;
a turbine arranged downstream of the combustion chamber;
a second annular combustion chamber arranged downstream of the turbine; and
a second turbine arranged downstream of this second combustion chamber;
wherein the second combustion chamber is a self-igniting combustion chamber including vortex-generating elements, and wherein the at least one compressor, the first turbine, and the second turbine are arranged on the common rotor shaft and operatively connected with the fan by the gear unit, such that the fan is driven by the excess shaft output of the common rotor shaft.

2. The jet engine as claimed in claim 1, wherein the at least one fan is a multistage fan.

3. The jet engine as claimed in claim 1, further comprising a diffuser arranged upstream of the second combustion chamber.

4. The jet engine as claimed in claim 1, wherein the vortex-generating elements include outflow-side surfaces having have a jump in cross section.

5. The jet engine as claimed in claim 1, further comprising means for injecting a main fuel in the second combustion chamber downstream of the vortex-generating elements.

6. The jet engine as claimed in claim 5, further comprising a plurality of fuel lances arranged in the peripheral direction of the second combustion chamber through which fuel lances the main fuel can be introduced.

7. The jet engine as claimed in claim 1, wherein the first combustion chamber comprises at least one premix burner.
